(19) United States
(12) Patent Application Publication
(10) Pub. No.: US 2014/0355274 A1
(43) Pub. Date: Dec. 4, 2014

(54) LED RETROFIT REMOVABLE TRIMS AND LED RECESSED LIGHT KIT WITH REMOVABLE TRIM

(71) Applicant: EVOLUTION LIGHTING, LLC, MIAMI LAKES, FL (US)

(72) Inventors: Dwight D. Santiago, Summerfield, NC (US); Timothy J. Haubach, Allison Park, PA (US)

(73) Assignee: EVOLUTION LIGHTING, LLC, MIAMI LAKES, FL (US)

(21) Appl. No.: 14/293,210

(22) Filed: Jun. 2, 2014

Related U.S. Application Data
(60) Provisional application No. 61/829,694, filed on May 31, 2013.

(51) Int. Cl. F21V 15/01

(52) U.S. Cl. CPC F21V 15/01
USPC 362/374

(57) ABSTRACT

In a trim component for a ceiling light fixture has a mechanical, twist-lock design that engages lugs on a canister housing, enabling the trim to be removed and replaced. The trim component may have twin torsion attachment springs attached that hold the trim component snug against a canister that is mounted in the ceiling. The trim component may include spring clips that provide a friction fit inside an existing canister.

### CROSS REFERENCE TO RELATED APPLICATIONS

This application claims the benefit of U.S. Provisional Application No. 61/829,694, filed May 31, 2013, the entire contents of which is herein incorporated by reference.

The inventors have developed a removable trim component having sufficient versatility to be usable for recess lighting retrofit and kit designs. In one embodiment, the trim component has a mechanical, twist-lock design that is made from cast metal. In an alternative embodiment, the trim component may have conventional twin torsion attachment springs attached that hold the trim component snug against a canister that is mounted in the ceiling. In lighting fixtures having a fixed canister, the inner housing and LED light, which may or may not include a gimbal feature, may rotate within the canister and trim. In other embodiments, the trim may include spring clips that provide a friction fit inside an existing canister. The type of attachment may depend upon the size (diameter) of the canister, and it is common for retrofit applications that the removable trim component will attach to 4″ canisters using spring clips while attachments to 5″ or 6″ canisters will typically be attached with twin torsion attachment springs.

The design is compatible with flood and gimbal lamp designs for both retrofit and kit models. The component is superior to existing trim components in method of fastening and product flexibility. The twist and lock trim component is for light emitting diode (LED) lighting applications, and creates a semi-permanent yet removable trim. This is superior to incandescent bulb trim systems in which the trim must be removed regularly in order to change the bulb.

In some embodiments, the removable trim component includes a glass plate that covers the opening and renders the trim component watertight, hence suitable for use in shower stalls and elsewhere in bathrooms. The glass plate feature may also render the trim component as being airtight. In an embodiment, a rubber or other flexible gasket may be used to enhance the water- or air-tightness of the trim component.

### BRIEF DESCRIPTION OF THE DRAWINGS

FIG. 1 depicts a removable trim component and a lamp housing to which it may be attached.

FIG. 2 shows the underside of the trim component of FIG. 1.

FIG. 3 shows another embodiment of the trim component and a lamp housing to which it may be attached.

FIG. 4 shows the underside of the trim component of FIG. 3.

FIG. 5 shows an embodiment of the trim component having twin torsion attachment springs and a lamp housing to which it may be attached.

FIG. 6 shows the underside of the trim component of FIG. 5.

FIG. 7 shows a lighting housing with an attached trim component having a watertight trim component with a glass insulator.

FIG. 8 shows the underside of the trim component of FIG. 7.

### DETAILED DESCRIPTION OF THE PREFERRED EMBODIMENTS

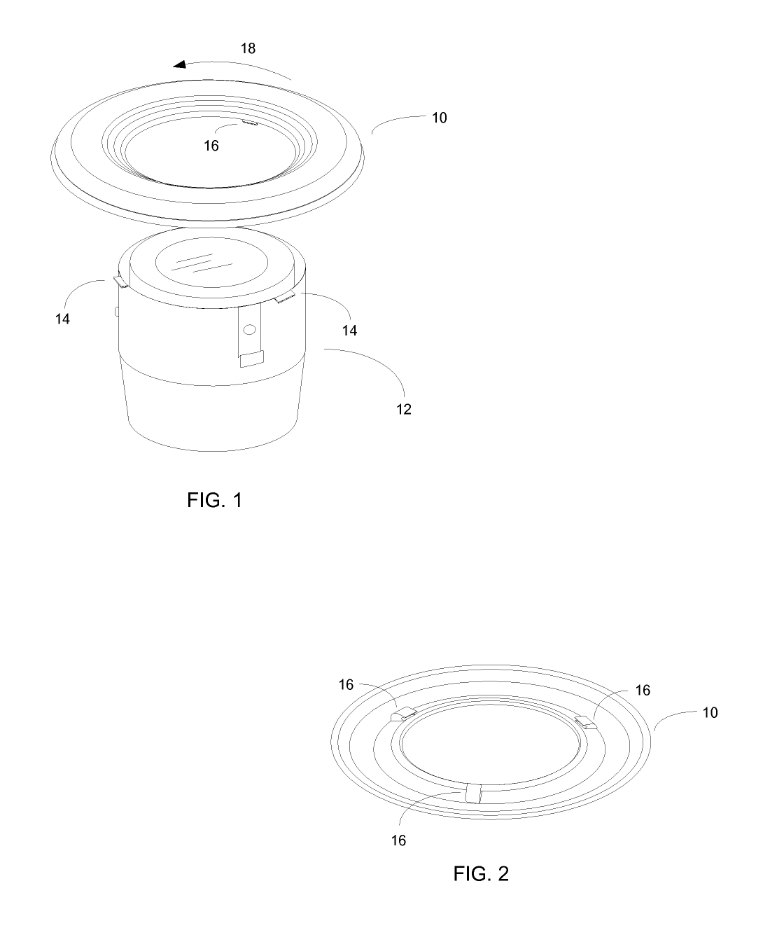

FIG. 1 depicts a lamp housing 12 and a trim component 10. Lugs 14 on the housing 12 engage corresponding hooks 16 on the trim component. When the trim component 10 is twisted in the direction indicated by arrow 18, the trim component hooks 16 become tightly engaged with the lamp housing lugs 14.

FIG. 2 shows the underside of trim component 10, and provides a clearer view of hooks 16.

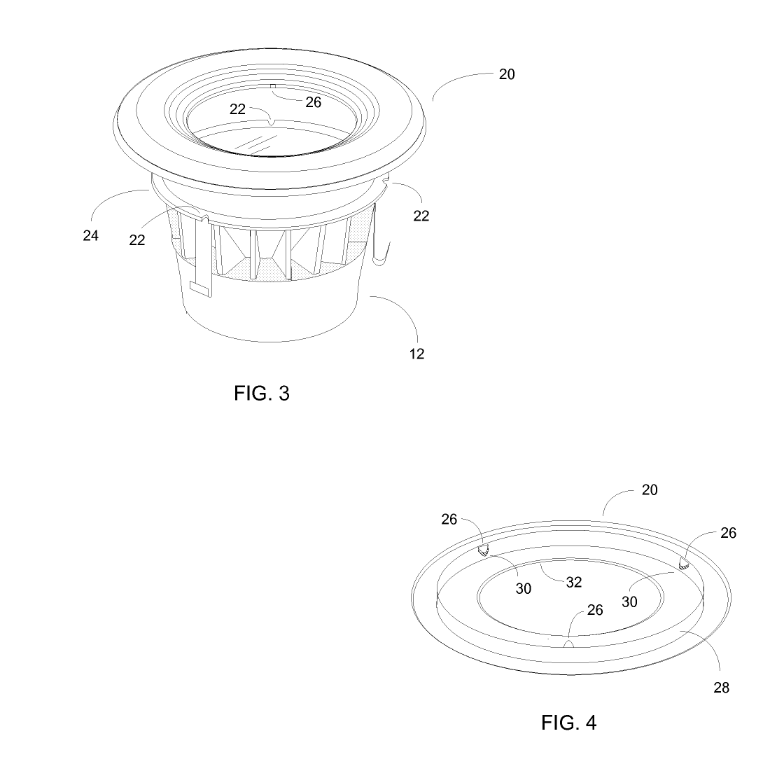

FIG. 3 shows another embodiment of a trim component 20 in which hooks have been replaced by beads 26. The beads fit into indentations 22 on the rim 24 of lighting housing 12. With this embodiment, the trim does not “lock” to the housing, but may be rotatable on the housing and may be rotated as necessary to provide directional lighting when the housing includes a gimbaled component.

FIG. 4 shows the underside of trim component 20, in which beads 26 are integrally attached to the inside of flange 28. As attached, a space 30 may be formed between bead 26 and an inner lip 32 of trim component 20. In this configuration, trim component 20 may be matched with lamp housing 12 by fully inserting beads 26 into indentations 22. When space 30 becomes aligned with lip 24, trim component 20 may be twisted such that it becomes securely attached to lamp housing 12.

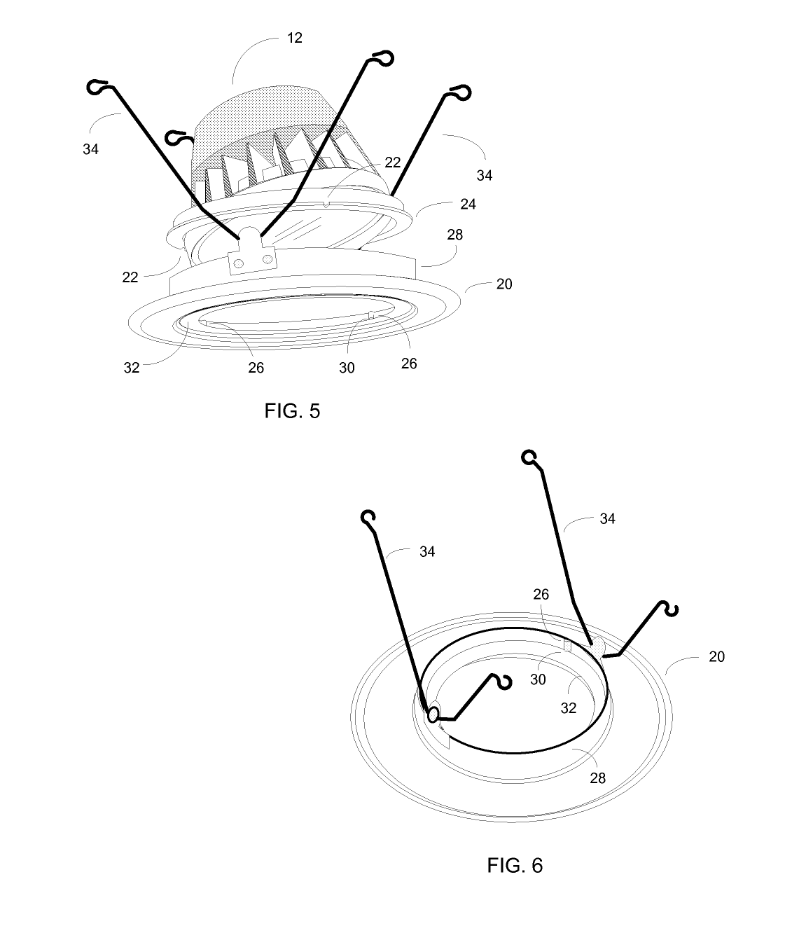

FIG. 5 depicts a trim component 20 having beads 26 positioned beneath a lamp housing 12 prior to becoming attached to the housing. Space 30 between bead 26 and inner lip 32 is visible in FIG. 5. Twin torsion attachment springs 34 are attached at opposite sides of trim component 20, and may be used to secure trim component to a housing canister (not shown) that is mounted within a ceiling.

FIG. 6 shows the opposite side of trim component 20 of FIG. 5 Twin torsion attachment springs 34, which may optionally be present, depending upon the canister to which the fixture is appurtenant, may be used to secure the trim component to a canister. In this case, a twisting attachment between the beads 26 of the trim component 20 and the rim 24 of the lamp housing may provide additional support to the entire assembly.

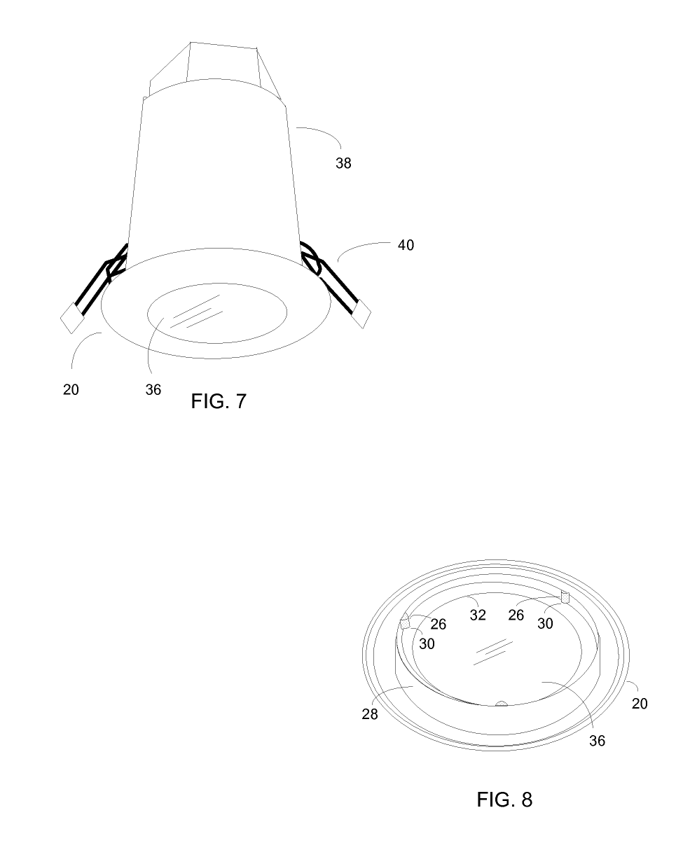

FIG. 7 shows a lamp housing including a canister 38 mounted to a junction box that may be affixed to a ceiling. Spring clips 40 secure the housing to a ceiling panel (not shown). Trim component 20 includes a glass cover 36, which will make the fixture watertight from moisture that may be within, e.g., a shower enclosure or other damp space below the ceiling.

FIG. 8 depicts the underside of the trim component having a glass cover 36, beads 26 to secure the cover against a lamp housing, an internal flange 28, to which the beads 26 are attached, and spaces 30 between beads 26 and inner lip 32. If desired, a gasket may be used between glass cover 36 and inner lip 32 to enhance the fixture's ability to be watertight and airtight.

The present invention has been described in the context of a number of embodiments, a number of variations and examples thereof. It is to be understood, however, that other expedients known to those skilled in the art or disclosed herein may be employed without departing from the spirit of the invention.

I claim:

1. In a lighting fixture having a housing, a removable trim component comprising:
a plate having an opening therethrough whereby light from a bulb in said housing may be projected through said opening,
said plate having a first side and a second side,
said plate having a plurality of hooks on said first side, said hooks being disposed about said opening and being configured to interlock with corresponding lugs on said housing,
whereby said hooks may snugly engage said lugs when said plate is placed adjacent said housing and twisted until said hooks and said lugs are engaged,
and said hooks and lugs may be disengaged when said plate is turned in the opposite direction.

2. The removable trim component claimed in claim 1 further comprising said housing having a circular cross section in the vicinity of said plate and said lugs being disposed about the circumference of said housing,
said opening being circumferential and having a diameter large enough to extend around said housing, and
said hooks extending into said opening.
